(19) United States
(12) Patent Application Publication
(10) Pub. No.: US 2026/0332041 A1
(43) Pub. Date: Oct. 22, 2026

(54) HIGH-SPEED INTRODUCTION DEVICE AND POWER CONTROL CIRCUIT

(71) Applicant: Mitsubishi Electric Corporation, TOKYO (JP)

(72) Inventors: Toshihiko TAKEMATSU, Chiyoda-ku, TOKYO (JP); Takayuki KAI, Chiyoda-ku, TOKYO (JP); Yu NISHIO, Chiyoda-ku, TOKYO (JP)

(73) Assignee: Mitsubishi Electric Corporation, TOKYO (JP)

(21) Appl. No.: 19/491,167

(22) PCT Filed: Jun. 16, 2023
(86) PCT No.: PCT/JP2023/022415

§ 371 Date: Dec. 8, 2025

(51) Int. Cl. H02M 1/32; H01H 71/02; H01H 79/00; H02N 2/18

(52) U.S. Cl. CPC H02M 1/325; H01H 71/0214; H01H 79/00; H02N 2/18; H01H 2071/0292

(57) ABSTRACT

A high-speed introduction device includes a first electrode, a second electrode, and a discharge induction mechanism. The second electrode is spaced apart from the first electrode. The discharge induction mechanism induces a discharge between the first electrode and the second electrode. The discharge induction mechanism includes a voltage generation element and a non-electrical energy application unit to apply non-electrical energy to the voltage generation element.

### TECHNICAL FIELD

The present disclosure relates to a high-speed introduction device and a power control circuit.

### BACKGROUND ART

The microfilm of Japanese Utility Model Application No. 62-13775 (Japanese Utility Model Laying-Open No. 63-123026), PTL 1, discloses a high-speed introduction device including a fixed electrode, a movable electrode, a trigger electrode, a trigger voltage generation unit, and a control unit. When an introduction command signal is supplied to the control unit, the control unit supplies a start signal to the trigger voltage generation unit. The trigger voltage generation unit receives the start signal and applies a trigger voltage between the fixed electrode and the trigger electrode. A first discharge occurs between the fixed electrode and the trigger electrode, and then, due to the effect of the first discharge, a second discharge occurs between the movable electrode and the fixed electrode.

### CITATION LIST

### Patent Literature

PTL 1: Microfilm of Japanese Utility Model Application No. S62-13775 (Japanese Utility Model Laying-Open No. S63-123026)

### SUMMARY OF INVENTION

### Technical Problem

In PTL 1, in order to generate the first discharge between the fixed electrode and the trigger electrode, the trigger voltage generation unit needs to be formed of a high-voltage circuit. Further, the control unit needs to be formed of a control circuit that controls the high-voltage circuit. However, the high-voltage circuit and the control circuit that controls the high-voltage circuit are costly and have low long-term reliability. The present disclosure has been made in view of the above problem. An object of the present disclosure is to provide a high-speed introduction device and a power control circuit that are less costly and have higher long-term reliability.

### Solution to Problem

A high-speed introduction device of the present disclosure includes a first electrode, a second electrode, and a discharge induction mechanism. The second electrode is spaced apart from the first electrode. The discharge induction mechanism induces a discharge between the first electrode and the second electrode. The discharge induction mechanism includes a voltage generation element and a non-electrical energy application unit to apply non-electrical energy to the voltage generation element.

A power control circuit of the present disclosure includes a module circuit and the high-speed introduction device of the present disclosure. The high-speed introduction device is electrically connected in parallel to the module circuit.

### Advantageous Effects of Invention

In the high-speed introduction device and the power control circuit of the present disclosure, the trigger voltage is generated not by a high-voltage circuit and a control circuit that controls the high-voltage circuit, but by the voltage generation element. Therefore, the high-speed introduction device and the power control circuit are less costly and have higher long-term reliability.

### BRIEF DESCRIPTION OF DRAWINGS

FIG. 1 is a schematic sectional view of a high-speed introduction device of Embodiment 1.

FIG. 2 is a schematic sectional view showing an operating state of the high-speed introduction device of Embodiment 1.

FIG. 3 is a schematic sectional view showing an operating state, following the operating state shown in FIG. 2, of the high-speed introduction device of Embodiment 1.

FIG. 4 is a schematic sectional view showing an operating state, following the operating state shown in FIG. 3, of the high-speed introduction device of Embodiment 1.

FIG. 5 is a partially-enlarged schematic sectional view of a high-speed introduction device of a first modification of Embodiment 1.

FIG. 6 is a partially-enlarged schematic sectional view of a high-speed introduction device of a second modification of Embodiment 1.

FIG. 7 is another partially-enlarged schematic sectional view of the high-speed introduction device of the second modification of Embodiment 1.

FIG. 8 is a schematic sectional view of a high-speed introduction device of Embodiment 2.

FIG. 9 is a schematic sectional view showing an operating state of the high-speed introduction device of Embodiment 2.

FIG. 10 is a schematic sectional view showing an operating state, following the operating state shown in FIG. 9, of the high-speed introduction device of Embodiment 2.

FIG. 11 is a partially-enlarged schematic sectional view of a high-speed introduction device of Embodiment 3.

FIG. 12 is a schematic sectional view showing an operating state of the high-speed introduction device of Embodiment 3.

FIG. 13 is a partially-enlarged schematic sectional view of a high-speed introduction device of Embodiment 4.

FIG. 14 is a schematic sectional view showing an operating state of the high-speed introduction device of Embodiment 4.

FIG. 15 is a schematic sectional view showing an operating state, following the operating state shown in FIG. 14, of the high-speed introduction device of Embodiment 4.

FIG. 16 is a partially-enlarged schematic sectional view of a high-speed introduction device of Embodiment 5.

FIG. 17 is a schematic sectional view showing an operating state of the high-speed introduction device of Embodiment 5.

FIG. 18 is a schematic sectional view showing an operating state, following the operating state shown in FIG. 17, of the high-speed introduction device of Embodiment 5.

FIG. 19 is a schematic sectional view of a high-speed introduction device of Embodiment 6.

FIG. 20 is a schematic sectional view showing an operating state of the high-speed introduction device of Embodiment 6.

FIG. 21 is a schematic sectional view showing an operating state, following the operating state shown in FIG. 20, of the high-speed introduction device of Embodiment 6.

FIG. 22 is a schematic sectional view of a high-speed introduction device of Embodiment 7.

FIG. 23 is a schematic sectional view showing an operating state of the high-speed introduction device of Embodiment 7.

FIG. 24 is a schematic sectional view showing an operating state, following the operating state shown in FIG. 23, of the high-speed introduction device of Embodiment 7.

FIG. 25 is a schematic sectional view showing an operating state, following the operating state shown in FIG. 24, of the high-speed introduction device of Embodiment 7.

FIG. 26 is a schematic sectional view of a high-speed introduction device of Embodiment 8.

FIG. 27 is a schematic sectional view showing an operating state of the high-speed introduction device of Embodiment 8.

FIG. 28 is a schematic sectional view showing an operating state, following the operating state shown in FIG. 27, of the high-speed introduction device of Embodiment 8.

FIG. 29 is a schematic sectional view showing an operating state, following the operating state shown in FIG. 28, of the high-speed introduction device of Embodiment 8.

FIG. 30 is a schematic diagram of a power converter of Embodiment 9.

FIG. 31 is a schematic diagram of a power control circuit of Embodiment 9.

### DESCRIPTION OF EMBODIMENTS

Embodiments of the present disclosure will be described below. The same components have the same reference sings allotted, and description thereof will not be repeated.

### EMBODIMENT 1

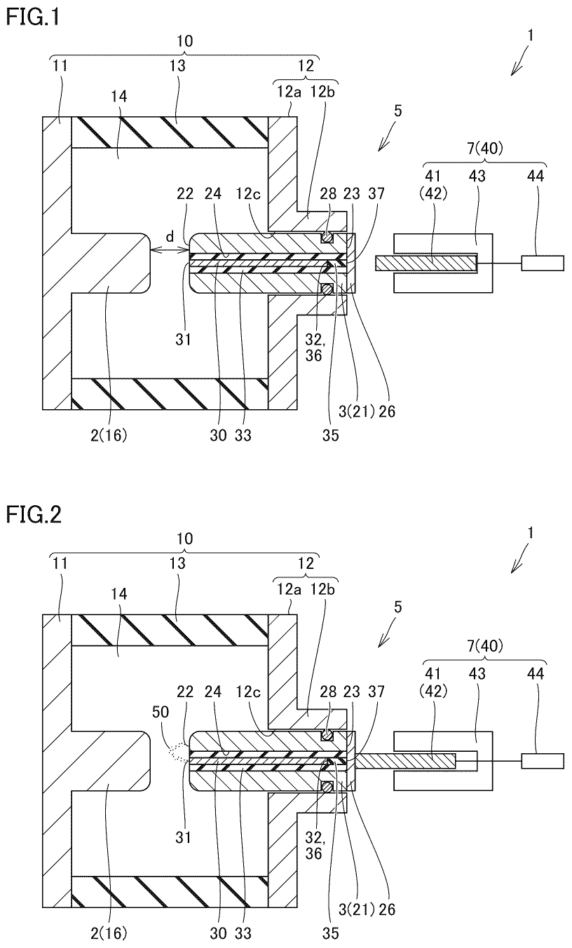

Referring to FIG. 1, a high-speed introduction device 1 of Embodiment 1 will be described. High-speed introduction device 1 is electrically connected in parallel to an electrical device (not shown) to be protected by high-speed introduction device 1. High-speed introduction device 1 diverts a fault current from the electrical device in a short period of time, preventing the electrical device from being damaged by the fault current. High-speed introduction device 1 includes a first electrode 2, a second electrode 3, and a discharge induction mechanism 5. High-speed introduction device 1 may further include a container 10, a sliding member 28, and an insulating member 33.

Container 10 includes a first main electrode 11, a second main electrode 12, and an insulating hollow body 13.

First main electrode 11 and second main electrode 12 are electrically connected to the electrical device (not shown) to be protected by high-speed introduction device 1.

First main electrode 11 closes one opening end of insulating hollow body 13. First main electrode 11 is formed of, for example, a metallic material such as copper (Cu).

Second main electrode 12 is spaced apart from first main electrode 11. Specifically, second main electrode 12 is spaced apart from first main electrode 11 by insulating hollow body 13. Second main electrode 12 covers the other opening end of insulating hollow body 13. Second main electrode 12 is formed of, for example, a metallic material such as copper (Cu). Second main electrode 12 may be formed of the same material as that of first main electrode 11.

Second main electrode 12 includes a flange portion 12a and a cylindrical portion 12b. Flange portion 12a covers the other opening end of insulating hollow body 13. Cylindrical portion 12b is connected to flange portion 12a. Cylindrical portion 12b protrudes from flange portion 12a to the side opposite to insulating hollow body 13 relative to flange portion 12a. A through hole 12c is provided in second main electrode 12. Specifically, through hole 12c is provided in flange portion 12a and cylindrical portion 12b. A part of second electrode 3 is disposed in through hole 12c. Through hole 12c may function as a guide hole for movable electrode 21.

Insulating hollow body 13 electrically insulates second main electrode 12 from first main electrode 11. Insulating hollow body 13 is formed of an insulating material such as ceramic, bulk molding compound (BMC), or glass epoxy.

An insulated space 14 is defined in container 10 by first main electrode 11, second main electrode 12, and insulating hollow body 13. The medium of insulated space 14 may be an insulating gas such as air or sulfur hexafluoride, or may be a vacuum.

First electrode 2 is electrically connected to the electrical device (not shown) to be protected by high-speed introduction device 1 via first main electrode 11. First electrode 2 may be a fixed electrode 16. First electrode 2 may be, for example, formed integrally with first main electrode 11. First electrode 2 may be disposed in insulated space 14 of container 10. First electrode 2 is formed of a conductive material. First electrode 2 is formed of, for example, a metallic material such as copper (Cu). First electrode 2 may be formed of the same material as that of first main electrode 11.

Second electrode 3 is electrically connected to the electrical device (not shown) to be protected by high-speed introduction device 1 via second main electrode 12 and sliding member 28. Second electrode 3 may be a movable electrode 21 that is movable relative to fixed electrode 16 and second main electrode 12. Second electrode 3 may be inserted into through hole 12c of container 10. Second electrode 3 is formed of a conductive material. Second electrode 3 is formed of, for example, a metallic material such as copper (Cu). Second electrode 3 may be formed of the same material as that of second main electrode 12. Second electrode 3 may be formed of the same material as that of first electrode 2.

Second electrode 3 includes an end portion 22 and an end portion 23 opposite to end portion 22. End portions 22, 23 are, for example, the opposite ends of second electrode 3 in the longitudinal direction. End portion 22 of second electrode 3 faces first electrode 2. End portion 22 of second electrode 3 may be disposed in insulated space 14 of container 10. End portion 23 of second electrode 3 faces movable member 41. A hole 24 extending from end portion 22 to end portion 23 is provided in second electrode 3. Second electrode 3 is a hollow conductive body.

At least one sliding member 28 is disposed between movable electrode 21 and container 10 in through hole 12c of container 10. More specifically, sliding member 28 is disposed between movable electrode 21 and second main electrode 12 and is in contact with movable electrode 21 and second main electrode 12. Sliding member 28 is formed of a conductive material such as metal and electrically connects movable electrode 21 to second main electrode 12. Sliding member 28 is, for example, a ring-shaped spring. Sliding member 28 is fixed to movable electrode 21 or second main electrode 12.

A plurality of sliding members 28 may be disposed between movable electrode 21 and second main electrode 12 in through hole 12c of container 10. Since the contact area between sliding member 28 and movable electrode 21 and the contact area between sliding member 28 and second main electrode 12 increase, the heat generated due to the contact resistance between sliding member 28 and movable electrode 21 and the contact resistance between sliding member 28 and second main electrode 12 may decrease.

Discharge induction mechanism 5 induces a discharge between first electrode 2 and second electrode 3. Discharge induction mechanism 5 includes a voltage generation element 35 and a non-electrical energy application unit 7. Discharge induction mechanism 5 may further include a conductive plate 26 and a trigger electrode 30.

Voltage generation element 35 includes an end portion 36 and an end portion 37 opposite to end portion 36. When non-electrical energy, such as mechanical energy, thermal energy, or magnetic energy, is applied to voltage generation element 35, a potential difference is generated between end portion 36 and end portion 37, and voltage generation element 35 outputs a trigger voltage. Voltage generation element 35 is, for example, a piezoelectric element that generates a voltage when mechanical energy (e.g., pressure) is applied thereto. The piezoelectric element is formed of, for example, a dielectric material having a piezoelectric effect, such as lead zirconate titanate (PZT).

Voltage generation element 35 is disposed in hole 24 of second electrode 3. Voltage generation element 35 is electrically connected to second electrode 3 and trigger electrode 30. For example, voltage generation element 35 may be electrically connected to second electrode 3 via conductive plate 26. Voltage generation element 35 may come into contact with trigger electrode 30.

Trigger electrode 30 is spaced apart from first electrode 2 and is electrically insulated from first electrode 2. Trigger electrode 30 may be disposed in hole 24 of second electrode 3. Trigger electrode 30 is electrically insulated from second electrode 3 by insulating member 33 and voltage generation element 35. The distance between trigger electrode 30 and second electrode 3 is smaller than the distance between first electrode 2 and second electrode 3.

Trigger electrode 30 includes end portions 31, 32. End portions 31, 32 are, for example, the opposite ends of trigger electrode 30 in the longitudinal direction. End portion 31 of trigger electrode 30 is proximate to end portion 22 of second electrode 3 and faces the space between first electrode 2 and second electrode 3. End portion 31 of trigger electrode 30 is distant from end portion 22 of second electrode 3 by insulating member 33. End portion 31 of trigger electrode 30 faces first electrode 2 and is disposed in container 10. The distance between end portion 31 of trigger electrode 30 and end portion 22 of second electrode 3 is smaller than the distance between first electrode 2 and end portion 22 of second electrode 3. End portion 31 of trigger electrode 30 may be positioned closer to end portion 22 of second electrode 3 than to first electrode 2. End portion 32 of trigger electrode 30 is proximate to end portion 23 of second electrode 3. End portion 32 of trigger electrode 30 is in contact with end portion 36 of voltage generation element 35.

Conductive plate 26 electrically connects second electrode 3 to voltage generation element 35. Specifically, conductive plate 26 is disposed on end portion 23 of second electrode 3 and is in contact with second electrode 3. Conductive plate 26 is positioned on end portion 37 of voltage generation element 35 and is in contact with voltage generation element 35.

Non-electrical energy application unit 7 applies non-electrical energy, such as mechanical energy, thermal energy, or magnetic energy, to voltage generation element 35. In the present embodiment, non-electrical energy application unit 7 is a drive unit 40 that applies mechanical energy (e.g., pressure) to voltage generation element 35.

Drive unit 40 includes a movable member 41, a housing 43, and a moving mechanism 44. Movable member 41 is movable relative to housing 43. Movable member 41 is, for example, a movable rod 42. Movable member 41 can press voltage generation element 35 to apply mechanical energy such as pressure to voltage generation element 35. Specifically, as shown in FIG. 2, movable member 41 presses conductive plate 26, thereby pressing voltage generation element 35 that is in contact with conductive plate 26. Housing 43 accommodates movable member 41. Moving mechanism 44 can move movable member 41. Moving mechanism 44 may be, for example, a linear motion mechanism including a ball screw and a motor, or may be a movable lever. When second electrode 3 is movable electrode 21, movable member 41 can move movable electrode 21.

Insulating member 33 has, for example, a cylindrical shape and is disposed in hole 24 of second electrode 3. Trigger electrode 30 and voltage generation element 35 are disposed in the hole of insulating member 33. Insulating member 33 is disposed between second electrode 3 and trigger electrode 30, and electrically insulates trigger electrode 30 from second electrode 3. Insulating member 33 is disposed between second electrode 3 and voltage generation element 35. Insulating member 33 is formed of an insulating material such as ceramic, bulk molding compound (BMC), or glass epoxy.

Referring to FIGS. 1 to 4, description will be given of an operation of high-speed introduction device 1 of the present embodiment when first electrode 2 is fixed electrode 16 and second electrode 3 is movable electrode 21.

When no fault current is detected, as shown in FIG. 1, movable electrode 21 is distant from fixed electrode 16 by a distance d. Distance d is not less than the insulation distance between fixed electrode 16 and movable electrode 21. Even if an approximately equal voltage to the voltage applied to the electrical device (not shown) connected in parallel to high-speed introduction device 1 is applied between fixed electrode 16 and movable electrode 21, thus, fixed electrode 16 and movable electrode 21 are not electrically conductive with each other. A normal current flows through the electrical device.

When a fault current is detected, an introduction command signal is input to non-electrical energy application unit 7 (e.g., drive unit 40). Moving mechanism 44 moves movable member 41 (movable rod 42) toward movable electrode 21. As shown in FIG. 2, movable member 41 and voltage generation element 35 are pressed by movable member 41 via conductive plate 26. Since voltage generation element 35 is a piezoelectric element, a trigger voltage is generated between end portion 36 and end portion 37 of voltage generation element 35.

End portion 36 of voltage generation element 35 is in contact with end portion 32 of trigger electrode 30. End portion 37 of voltage generation element 35 is in contact with conductive plate 26, and conductive plate 26 is in contact with movable electrode 21. Thus, the trigger voltage generated in voltage generation element 35 is applied between trigger electrode 30 and movable electrode 21. A voltage higher than the breakdown voltage of the medium between trigger electrode 30 and movable electrode 21 is applied between end portion 31 of trigger electrode 30 and end portion 22 of movable electrode 21. Thus, a first discharge 50 occurs between end portion 31 of trigger electrode 30 and end portion 22 of movable electrode 21.

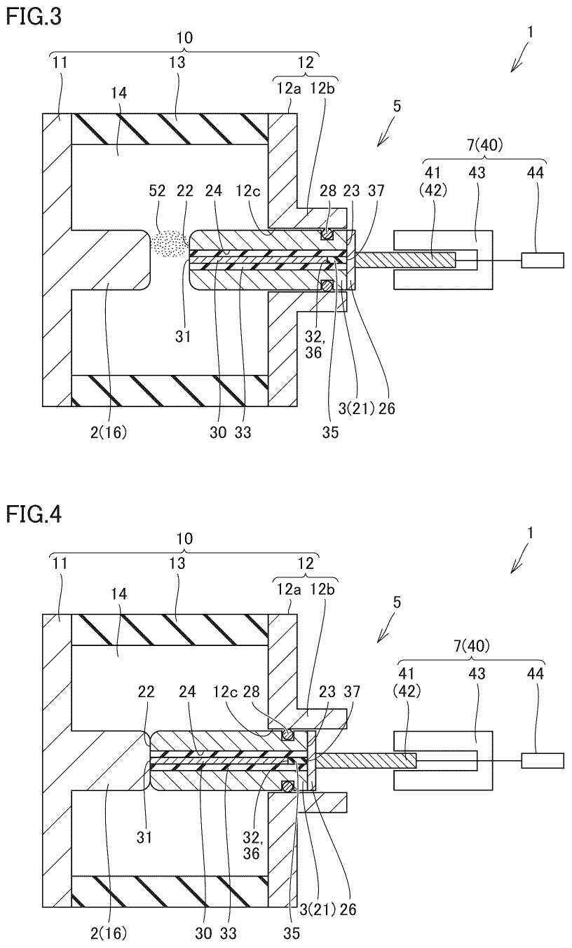

Charged particles are generated between fixed electrode 16 and movable electrode 21 due to first discharge 50. The charged particles reduce the breakdown voltage of the medium between fixed electrode 16 and movable electrode 21. Since first main electrode 11 and second main electrode 12 are connected in parallel to the electrical device (not shown) to be protected by high-speed introduction device 1, an approximately equal voltage to the voltage applied to the electrical device is applied between fixed electrode 16 and movable electrode 21. The voltage applied between fixed electrode 16 and movable electrode 21 becomes higher than the reduced breakdown voltage of the medium between fixed electrode 16 and movable electrode 21. As shown in FIG. 3, thus, a second discharge 52 occurs between fixed electrode 16 and movable electrode 21. Before movable electrode 21 comes into contact with fixed electrode 16, a conductive path is formed between fixed electrode 16 and movable electrode 21 by second discharge 52, causing movable electrode 21 to become electrically conductive with fixed electrode 16. Thus, before movable electrode 21 comes into contact with fixed electrode 16, the path of the fault current is switched from the electrical device to high-speed introduction device 1.

Movable member 41 further presses movable electrode 21 to move movable electrode 21 toward fixed electrode 16. As shown in FIG. 4, movable electrode 21 comes into contact with fixed electrode 16. The electrical conduction between fixed electrode 16 and movable electrode 21 switches from the electrical conduction via second discharge 52 to the electrical conduction due to the contact between fixed electrode 16 and movable electrode 21. The fault current continuously flows through high-speed introduction device 1. Thus, the electrical device can be protected from the fault current.

### Modifications

Referring to FIG. 5, in a first modification of the present embodiment, movable member 41 includes movable rod 42, a pressing member 45, and an elastic member such as a spring 46. Pressing member 45 can press voltage generation element 35 and movable electrode 21 via conductive plate 26. The elastic member is connected to movable rod 42 and pressing member 45.

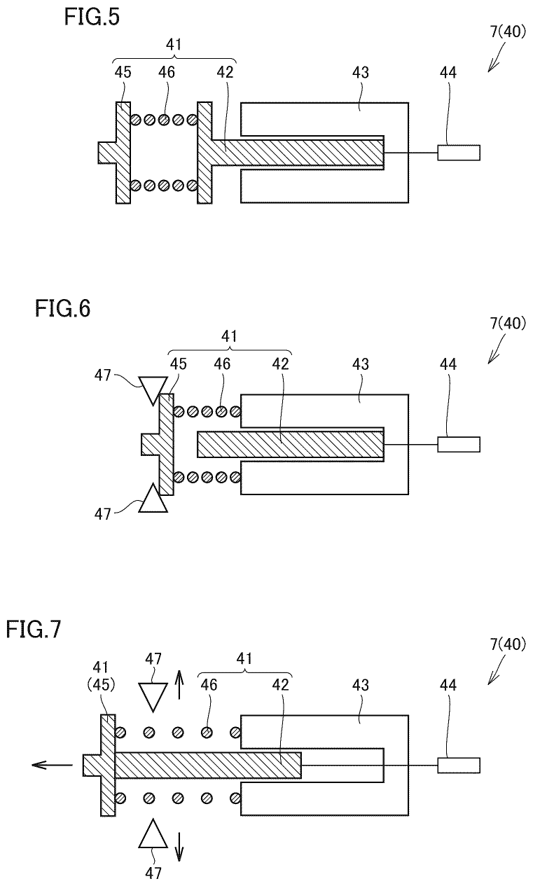

Referring to FIG. 6, in a second modification of the present embodiment, movable member 41 includes movable rod 42, pressing member 45, and a force-stored spring 46. Pressing member 45 can press voltage generation element 35 and movable electrode 21 via conductive plate 26. Force-stored spring 46 is connected to housing 43 and pressing member 45. Pressing member 45 can be pressed by movable rod 42 and can be biased by force-stored spring 46. The length of force-stored spring 46 is smaller than the natural length of spring 46. Specifically, drive unit 40 includes a stopper 47. Stopper 47 is, for example, a plunger. When no fault current is detected, pressing member 45 is in contact with stopper 47. Thus, the length of force-stored spring 46 becomes smaller than the natural length of spring 46, and the force of spring 46 is stored. Stopper 47 prevents pressing member 45 from moving toward voltage generation element 35 and movable electrode 21 against the biasing force of force-stored spring 46.

Referring to FIG. 7, when a fault current is detected, an introduction command signal is input to drive unit 40. Moving mechanism 44 moves movable rod 42 toward movable electrode 21. Movable rod 42 comes into contact with pressing member 45. The biasing force of force-stored spring 46 and the pressing force of movable rod 42 act on pressing member 45. Stopper 47 cannot withstand the biasing force of force-stored spring 46 and the pressing force of movable rod 42, allowing pressing member 45 to move toward voltage generation element 35 and movable electrode 21. Pressing member 45 moves toward voltage generation element 35 and movable electrode 21 and presses voltage generation element 35 and movable electrode 21 via conductive plate 26.

In a third modification of the present embodiment, voltage generation element 35 may be an induction coil that outputs magnetic energy.

The effects of high-speed introduction device 1 of the present embodiment will be described.

High-speed introduction device 1 of the present embodiment includes first electrode 2, second electrode 3, and discharge induction mechanism 5. Second electrode 3 is spaced apart from first electrode 2. Discharge induction mechanism 5 induces a discharge between first electrode 2 and second electrode 3. Discharge induction mechanism 5 includes voltage generation element 35 and non-electrical energy application unit 7 that can apply non-electrical energy to voltage generation element 35.

The trigger voltage is generated by voltage generation element 35, thus eliminating the need for a high-voltage circuit and a control circuit that controls the high-voltage circuit. Thus, high-speed introduction device 1 is less costly and has higher long-term reliability.

In high-speed introduction device 1 of the present embodiment, discharge induction mechanism 5 includes trigger electrode 30 connected to voltage generation element 35. Second electrode 3 and trigger electrode 30 are electrically connected to voltage generation element 35. Trigger electrode 30 includes end portion 31 facing the space between first electrode 2 and second electrode 3. The distance between end portion 31 of trigger electrode 30 and second electrode 3 is smaller than the distance between first electrode 2 and second electrode 3.

Even if the trigger voltage generated from voltage generation element 35 is smaller, thus, a discharge can be induced between first electrode 2 and second electrode 3. High-speed introduction device 1 can be miniaturized.

In high-speed introduction device 1 of the present embodiment, voltage generation element 35 is disposed in hole 24 of second electrode 3.

Thus, high-speed introduction device 1 can be miniaturized.

High-speed introduction device 1 of the present embodiment further includes insulating member 33. Insulating member 33 is disposed between trigger electrode 30 and second electrode 3.

Thus, trigger electrode 30 can be disposed in the vicinity of second electrode 3. High-speed introduction device 1 can be miniaturized.

In high-speed introduction device 1 of the present embodiment, voltage generation element 35 includes the first end portion (end portion 36) and the second end portion (end portion 37) opposite to the first end portion. Discharge induction mechanism 5 includes conductive plate 26. Trigger electrode 30 is in contact with the first end portion. Conductive plate 26 is in contact with the second end portion and second electrode 3.

The trigger voltage is generated by voltage generation element 35, thus eliminating the need for a high-voltage circuit and a control circuit that controls the high-voltage circuit. Thus, high-speed introduction device 1 is less costly and has higher long-term reliability.

In high-speed introduction device 1 of the present embodiment, voltage generation element 35 is a piezoelectric element. Non-electrical energy application unit 7 is drive unit 40 including movable member 41 that can apply mechanical energy to the piezoelectric element.

The trigger voltage is generated by the piezoelectric element, thus eliminating the need for a high-voltage circuit and a control circuit that controls the high-voltage circuit. Thus, high-speed introduction device 1 is less costly and has higher long-term reliability.

In high-speed introduction device 1 of the present embodiment, second electrode 3 is movable electrode 21. Movable member 41 can move movable electrode 21 toward first electrode 2.

Thus, before movable electrode 21 comes into contact with first electrode 2, movable electrode 21 is electrically conductive with first electrode 2. The path of the fault current is switched from the electrical device to be protected by high-speed introduction device 1 to high-speed introduction device 1 in a shorter period of time. Further, the trigger voltage is generated by voltage generation element 35, thus eliminating the need for a high-voltage circuit and a control circuit that controls the high-voltage circuit. Thus, high-speed introduction device 1 is less costly and has higher long-term reliability.

In high-speed introduction device 1 of the present embodiment, movable member 41 includes movable rod 42, pressing member 45 that can press movable electrode 21, and the elastic member (spring 46) connected to movable rod 42 and pressing member 45.

The elastic member (e.g., spring 46) can mitigate the impact force when movable rod 42 collides with movable electrode 21. This can prevent damage to voltage generation element 35.

In high-speed introduction device 1 of the present embodiment, movable member 41 includes movable rod 42, pressing member 45 that can press movable electrode 21, and the force-stored spring (spring 46). Pressing member 45 can be pressed by movable rod 42 and is connected to the force-stored spring.

Spring 46 can mitigate the impact force when movable rod 42 presses movable electrode 21. This can prevent damage to voltage generation element 35.

### EMBODIMENT 2.

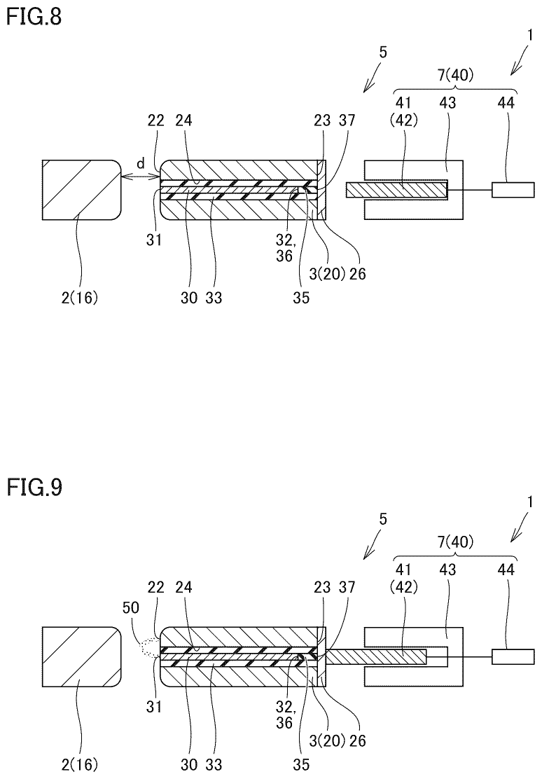

Referring to FIG. 8, high-speed introduction device 1 of Embodiment 2 will be described. High-speed introduction device 1 of the present embodiment has the same configuration as that of high-speed introduction device 1 of Embodiment 1, but differs mainly in the following points.

High-speed introduction device 1 of the present embodiment includes neither container 10 nor sliding member 28. Second electrode 3 is fixed electrode 20. The electrical device (not shown) to be protected by high-speed introduction device 1 is electrically connected to first electrode 2 and second electrode 3.

Referring to FIGS. 8 to 10, an operation of high-speed introduction device 1 of the present embodiment will be described.

When no fault current is detected, as shown in FIG. 8, second electrode 3 (fixed electrode 20) is distant from first electrode 2 (fixed electrode 16) by distance d. Distance d is not less than the insulation distance between first electrode 2 and second electrode 3. Even if an approximately equal voltage to the voltage applied to the electrical device (not shown) connected in parallel to high-speed introduction device 1 is applied between first electrode 2 and second electrode 3, thus, first electrode 2 and second electrode 3 are not electrically conductive with each other. A normal current flows through the electrical device.

When a fault current is detected, an introduction command signal is input to non-electrical energy application unit 7 (e.g., drive unit 40). Moving mechanism 44 moves movable member 41 (movable rod 42) toward second electrode 3. As shown in FIG. 9, voltage generation element 35 is pressed by movable member 41 via conductive plate 26. A trigger voltage is generated between end portion 36 and end portion 37 of voltage generation element 35.

The trigger voltage generated in voltage generation element 35 is applied between trigger electrode 30 and second electrode 3. A voltage higher than the breakdown voltage of the medium (e.g., air) between trigger electrode 30 and second electrode 3 is applied between end portion 31 of trigger electrode 30 and end portion 22 of second electrode 3. As shown in FIG. 9, thus, first discharge 50 occurs between end portion 31 of trigger electrode 30 and end portion 22 of second electrode 3.

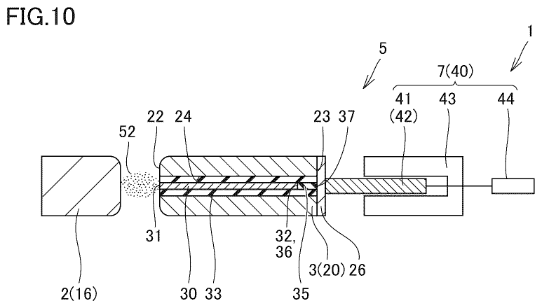

Charged particles are generated between first electrode 2 and second electrode 3 due to first discharge 50. The charged particles reduce the breakdown voltage of the medium between first electrode 2 and second electrode 3. Since first electrode 2 and second electrode 3 are connected in parallel to the electrical device (not shown) to be protected by high-speed introduction device 1, an approximately equal voltage to the voltage applied to the electrical device is applied between first electrode 2 and second electrode 3. The voltage applied between first electrode 2 and second electrode 3 becomes higher than the reduced breakdown voltage of the medium between first electrode 2 and second electrode 3. As shown in FIG. 10, thus, second discharge 52 occurs between first electrode 2 and second electrode 3. A conductive path is formed between first electrode 2 and second electrode 3 by second discharge 52, causing second electrode 3 to become electrically conductive with first electrode 2. As a result, the path of the fault current is switched from the electrical device to high-speed introduction device 1. Thus, the electrical device can be protected from the fault current.

High-speed introduction device 1 of the present embodiment achieves the same effects as those of high-speed introduction device 1 of Embodiment 1, which will be described below.

In high-speed introduction device 1 of the present embodiment, first electrode 2 is fixed electrode 16. Second electrode 3 is fixed electrode 20.

The trigger voltage is generated by voltage generation element 35, thus eliminating the need for a high-voltage circuit and a control circuit that controls the high-voltage circuit. Thus, high-speed introduction device 1 is less costly and has higher long-term reliability.

### EMBODIMENT 3

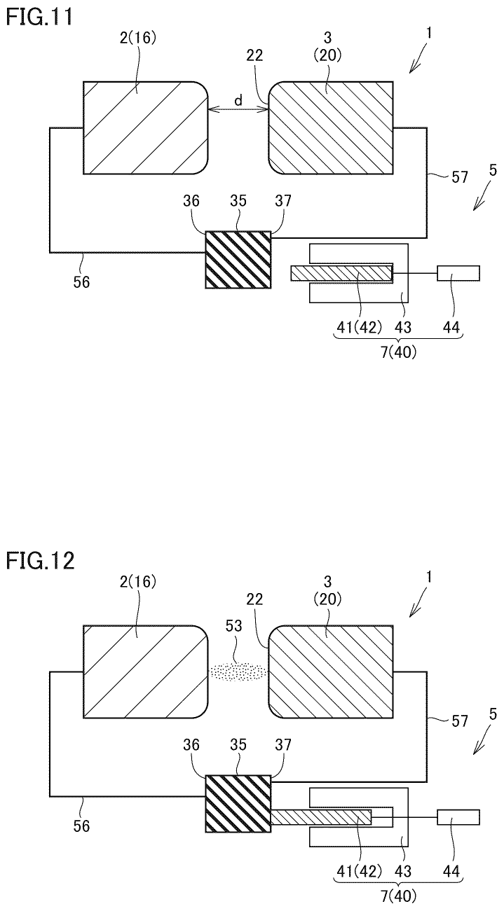

Referring to FIG. 11, high-speed introduction device 1 of Embodiment 3 will be described. High-speed introduction device 1 of the present embodiment has the same configuration as that of high-speed introduction device 1 of Embodiment 2, but differs mainly in the following points.

In the present embodiment, discharge induction mechanism 5 includes voltage generation element 35, non-electrical energy application unit 7, and wires 56, 57. Discharge induction mechanism 5 includes neither conductive plate 26 nor trigger electrode 30. Wire 56 is connected to first electrode 2 and end portion 36 of voltage generation element 35. Wire 57 is connected to second electrode 3 and end portion 37 of voltage generation element 35.

Voltage generation element 35 is disposed outside second electrode 3. High-speed introduction device 1 of the present embodiment does not include insulating member 33. Movable member 41 can come into contact with voltage generation element 35 and press voltage generation element 35.

Referring to FIGS. 11 and 12, an operation of high-speed introduction device 1 of the present embodiment will be described.

When no fault current is detected, as shown in FIG. 11, second electrode 3 (fixed electrode 20) is distant from first electrode 2 (fixed electrode 16) by distance d.

Distance d is not less than the insulation distance between first electrode 2 and second electrode 3. Even if an approximately equal voltage to the voltage applied to the electrical device (not shown) connected in parallel to high-speed introduction device 1 is applied between first electrode 2 and second electrode 3, thus, first electrode 2 and second electrode 3 are not electrically conductive with each other. A normal current flows through the electrical device (not shown) to be protected by high-speed introduction device 1, which is connected to first electrode 2 and second electrode 3.

When a fault current is detected, an introduction command signal is input to non-electrical energy application unit 7 (e.g., drive unit 40). Moving mechanism 44 moves movable member 41 (movable rod 42) toward second electrode 3. As shown in FIG. 11, voltage generation element 35 is pressed by movable member 41. A trigger voltage is generated between end portion 36 and end portion 37 of voltage generation element 35.

Since first electrode 2 and second electrode 3 are connected in parallel to the electrical device (not shown) to be protected by high-speed introduction device 1, an approximately equal voltage to the voltage applied to the electrical device is applied between first electrode 2 and second electrode 3. Further, the trigger voltage generated in voltage generation element 35 is applied between first electrode 2 and second electrode 3. Thus, the voltage applied between first electrode 2 and second electrode 3 becomes higher than the breakdown voltage of the medium between first electrode 2 and second electrode 3. As shown in FIG. 12, thus, a discharge 53 occurs between first electrode 2 and second electrode 3. A conductive path is formed between first electrode 2 and second electrode 3 by discharge 53, causing second electrode 3 to become electrically conductive with first electrode 2. As a result, the path of the fault current is switched from the electrical device to high-speed introduction device 1. Thus, the electrical device can be protected from the fault current.

High-speed introduction device 1 of the present embodiment achieves the same effects as those of high-speed introduction device 1 of Embodiment 1, which will be described below.

In high-speed introduction device 1 of the present embodiment, first electrode 2 and second electrode 3 are electrically connected to voltage generation element 35.

The trigger voltage is generated by voltage generation element 35, thus eliminating the need for a high-voltage circuit and a control circuit that controls the high-voltage circuit. Thus, high-speed introduction device 1 is less costly and has higher long-term reliability.

### EMBODIMENT 4.

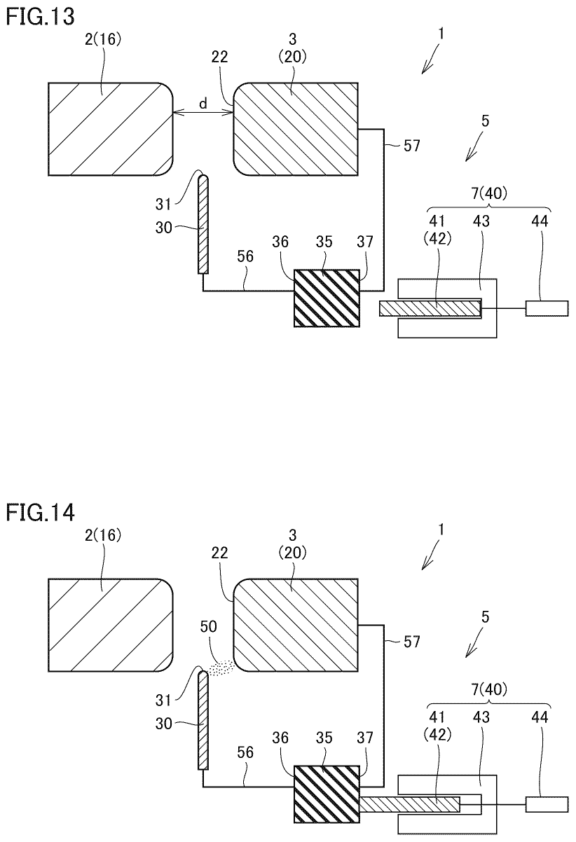

Referring to FIG. 13, high-speed introduction device 1 of Embodiment 4 will be described. High-speed introduction device 1 of the present embodiment has the same configuration as that of high-speed introduction device 1 of Embodiment 3, but differs mainly in the following points.

High-speed introduction device 1 of the present embodiment further includes trigger electrode 30. Trigger electrode 30 is disposed between first electrode 2 and second electrode 3. Specifically, end portion 31 of trigger electrode 30 is disposed between first electrode 2 and second electrode 3. The distance between end portion 31 of trigger electrode 30 and end portion 22 of second electrode 3 is smaller than the distance between first electrode 2 and second electrode 3. Voltage generation element 35 is electrically connected to trigger electrode 30 via wire 56. Voltage generation element 35 is electrically connected to second electrode 3 via wire 57.

Referring to FIGS. 13 to 15, an operation of high-speed introduction device 1 of the present embodiment will be described.

When no fault current is detected, as shown in FIG. 13, second electrode 3 is distant from first electrode 2 by distance d. Distance d is not less than the insulation distance between first electrode 2 and second electrode 3. Even if an approximately equal voltage to the voltage applied to the electrical device (not shown) connected in parallel to high-speed introduction device 1 is applied between first electrode 2 and second electrode 3, thus, first electrode 2 and second electrode 3 are not electrically conductive with each other. A normal current flows through the electrical device.

When a fault current is detected, an introduction command signal is input to non-electrical energy application unit 7 (e.g., drive unit 40). Moving mechanism 44 moves movable member 41 (movable rod 42) toward second electrode 3. As shown in FIG. 14, voltage generation element 35 is pressed by movable member 41. A trigger voltage is generated between end portion 36 and end portion 37 of voltage generation element 35.

The trigger voltage generated in voltage generation element 35 is applied between trigger electrode 30 and second electrode 3. A voltage higher than the breakdown voltage of the medium (e.g., air) between end portion 31 of trigger electrode 30 and second electrode 3 is applied between trigger electrode 30 and second electrode 3. As shown in FIG. 14, thus, first discharge 50 occurs between trigger electrode 30 and second electrode 3.

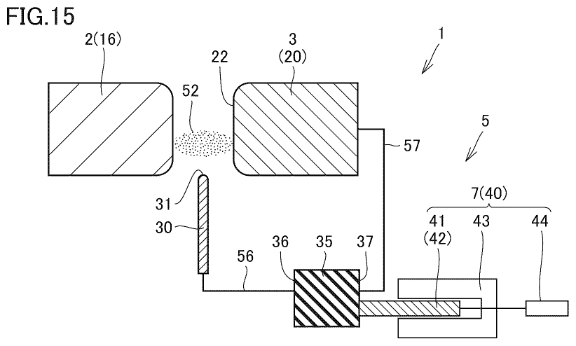

Charged particles are generated between first electrode 2 and second electrode 3 due to first discharge 50. The charged particles reduce the breakdown voltage of the medium between first electrode 2 and second electrode 3. Since first electrode 2 and second electrode 3 are connected in parallel to the electrical device (not shown) to be protected by high-speed introduction device 1, an approximately equal voltage to the voltage applied to the electrical device is applied between first electrode 2 and second electrode 3. The voltage applied between first electrode 2 and second electrode 3 becomes higher than the reduced breakdown voltage of the medium between first electrode 2 and second electrode 3. As shown in FIG. 15, thus, second discharge 52 occurs between first electrode 2 and second electrode 3. A conductive path is formed between first electrode 2 and second electrode 3 by second discharge 52, causing second electrode 3 to become electrically conductive with first electrode 2. As a result, the path of the fault current is switched from the electrical device to high-speed introduction device 1. Thus, the electrical device can be protected from the fault current.

High-speed introduction device 1 of the present embodiment achieves the same effects as those of high-speed introduction device 1 of Embodiment 1, which will be described below.

In high-speed introduction device 1 of the present embodiment, end portion 31 of trigger electrode 30 is disposed between first electrode 2 and second electrode 3.

Even if the trigger voltage generated from voltage generation element 35 is smaller, thus, a discharge can be induced between first electrode 2 and second electrode 3. High-speed introduction device 1 can be miniaturized.

### EMBODIMENT 5

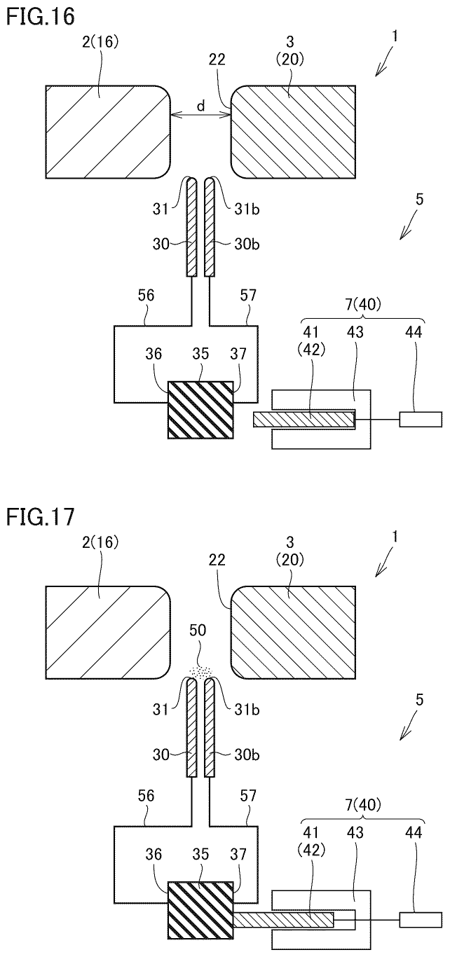

Referring to FIG. 16, high-speed introduction device 1 of Embodiment 5 will be described. High-speed introduction device 1 of the present embodiment has the same configuration as that of high-speed introduction device 1 of Embodiment 3, but differs mainly in the following points.

High-speed introduction device 1 of the present embodiment further includes trigger electrodes 30, 30b. Trigger electrodes 30, 30b are disposed between first electrode 2 and second electrode 3. Specifically, trigger electrode 30 includes end portion 31. Trigger electrode 30b includes an end portion 31b. End portion 31 of trigger electrode 30 and end portion 31b of trigger electrode 30b face the space between first electrode 2 and second electrode 3. The distance between end portion 31 of trigger electrode 30 and end portion 31b of trigger electrode 30b is smaller than the distance between end portion 31 of trigger electrode 30 and first electrode 2, smaller than the distance between end portion 31 of trigger electrode 30 and second electrode 3, smaller than the distance between end portion 31b of trigger electrode 30b and first electrode 2, and smaller than the distance between end portion 31b of trigger electrode 30b and second electrode 3.

Trigger electrodes 30, 30b are electrically connected to voltage generation element 35. Specifically, trigger electrode 30 is electrically connected to end portion 36 of voltage generation element 35 through wire 56. Trigger electrode 30b is electrically connected to end portion 37 of voltage generation element 35 through wire 57.

Referring to FIGS. 16 to 18, an operation of high-speed introduction device 1 of the present embodiment will be described.

When no fault current is detected, as shown in FIG. 16, second electrode 3 is distant from first electrode 2 by distance d. Distance d is not less than the insulation distance between first electrode 2 and second electrode 3. Even if an approximately equal voltage to the voltage applied to the electrical device (not shown) connected in parallel to high-speed introduction device 1 is applied between first electrode 2 and second electrode 3, thus, first electrode 2 and second electrode 3 are not electrically conductive with each other. A normal current flows through the electrical device.

When a fault current is detected, an introduction command signal is input to non-electrical energy application unit 7 (e.g., drive unit 40). Moving mechanism 44 moves movable member 41 (movable rod 42) toward second electrode 3. As shown in FIG. 17, voltage generation element 35 is pressed by movable member 41. A trigger voltage is generated between end portion 36 and end portion 37 of voltage generation element 35.

The trigger voltage generated in voltage generation element 35 is applied between trigger electrode 30 and trigger electrode 30b. A voltage higher than the breakdown voltage of the medium (e.g., air) between end portion 31 of trigger electrode 30 and end portion 31b of trigger electrode 30b is applied between trigger electrode 30 and trigger electrode 30b. As shown in FIG. 17, thus, first discharge 50 occurs between trigger electrode 30 and trigger electrode 30b.

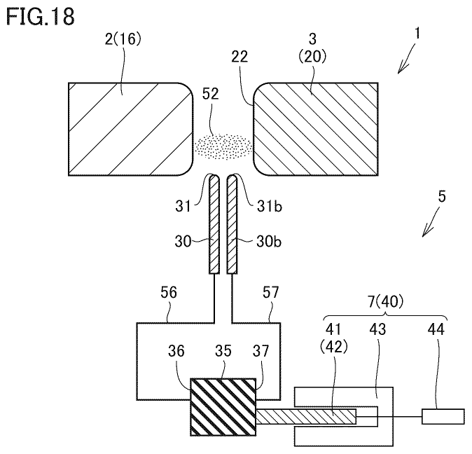

Charged particles are generated between first electrode 2 and second electrode 3 due to first discharge 50. The charged particles reduce the breakdown voltage of the medium between first electrode 2 and second electrode 3. Since first electrode 2 and second electrode 3 are connected in parallel to the electrical device (not shown) to be protected by high-speed introduction device 1, an approximately equal voltage to the voltage applied to the electrical device is applied between first electrode 2 and second electrode 3. The voltage applied between first electrode 2 and second electrode 3 becomes higher than the reduced breakdown voltage of the medium between first electrode 2 and second electrode 3. As shown in FIG. 18, thus, second discharge 52 occurs between first electrode 2 and second electrode 3. A conductive path is formed between first electrode 2 and second electrode 3 by second discharge 52, causing second electrode 3 to become electrically conductive with first electrode 2. As a result, the path of the fault current is switched from the electrical device to high-speed introduction device 1. Thus, the electrical device can be protected from the fault current.

High-speed introduction device 1 of the present embodiment achieves the same effects as those of high-speed introduction device 1 of Embodiment 1, which will be described below.

In high-speed introduction device 1 of the present embodiment, discharge induction mechanism 5 includes the first trigger electrode (trigger electrode 30) and the second trigger electrode (trigger electrode 30b). The first trigger electrode and the second trigger electrode are electrically connected to voltage generation element 35. End portion 31 of the first trigger electrode and end portion 31b of the second trigger electrode face the space between first electrode 2 and second electrode 3.

Even if the trigger voltage generated from voltage generation element 35 is smaller, thus, a discharge can be induced between first electrode 2 and second electrode 3. High-speed introduction device 1 can be miniaturized.

### EMBODIMENT 6

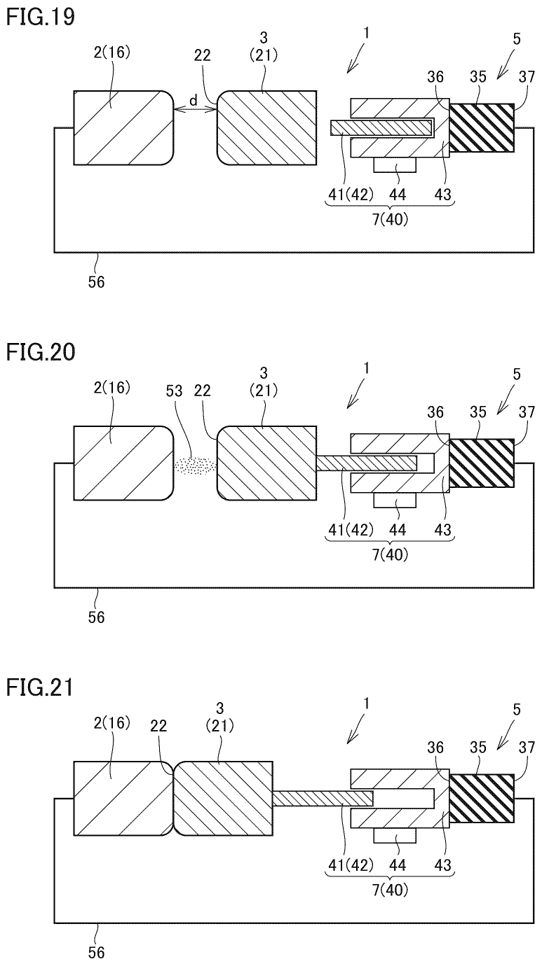

Referring to FIG. 19, high-speed introduction device 1 of Embodiment 6 will be described. High-speed introduction device 1 of the present embodiment has the same configuration as that of high-speed introduction device 1 of Embodiment 3, but differs mainly in the following points.

In the present embodiment, second electrode 3 is movable electrode 21. Movable member 41 and housing 43 have electrical conductivity and are electrically conductive with each other. Drive unit 40 (movable member 41) can press movable electrode 21 to move movable electrode 21 toward fixed electrode 16. End portion 36 of voltage generation element 35 is in contact with housing 43. End portion 37 of voltage generation element 35 is electrically conductive with first electrode 2 (fixed electrode 16). Specifically, wire 56 is connected to first electrode 2 (fixed electrode 16) and end portion 37 of voltage generation element 35. While movable member 41 is moving relative to housing 43, housing 43 receives a reaction force and presses voltage generation element 35. Thus, non-electrical energy application unit 7 applies non-electrical energy, such as mechanical energy, to voltage generation element 35. Voltage generation element 35 is pressed and outputs a trigger voltage.

Referring to FIGS. 19 to 21, an operation of high-speed introduction device 1 of the present embodiment will be described.

When no fault current is detected, as shown in FIG. 19, second electrode 3 (movable electrode 21) is distant from first electrode 2 (fixed electrode 16) by distance d. Distance d is not less than the insulation distance between first electrode 2 and second electrode 3. Even if an approximately equal voltage to the voltage applied to the electrical device (not shown) connected in parallel to high-speed introduction device 1 is applied between first electrode 2 and second electrode 3, thus, first electrode 2 and second electrode 3 are not electrically conductive with each other. A normal current flows through the electrical device (not shown) to be protected by high-speed introduction device 1, which is connected to first electrode 2 and second electrode 3.

When a fault current is detected, an introduction command signal is input to non-electrical energy application unit 7 (e.g., drive unit 40). Moving mechanism 44 moves movable member 41 (movable rod 42) toward second electrode 3. While movable member 41 is moving relative to housing 43, housing 43 receives a reaction force and presses voltage generation element 35. A trigger voltage is generated between end portion 36 and end portion 37 of voltage generation element 35.

As shown in FIG. 20, movable member 41 comes into contact with movable electrode 21 and presses movable electrode 21 toward fixed electrode 16. Movable electrode 21 is electrically connected to end portion 36 of voltage generation element 35 via movable member 41 and housing 43. Fixed electrode 16 is electrically connected to end portion 37 of voltage generation element 35 through wire 56. Thus, a trigger voltage is applied between fixed electrode 16 and movable electrode 21.

Since fixed electrode 16 and movable electrode 21 are connected in parallel to the electrical device (not shown) to be protected by high-speed introduction device 1, an approximately equal voltage to the voltage applied to the electrical device is applied between fixed electrode 16 and movable electrode 21. Further, the trigger voltage generated in voltage generation element 35 is applied between fixed electrode 16 and movable electrode 21. Thus, the voltage applied between fixed electrode 16 and movable electrode 21 becomes higher than the breakdown voltage of the medium between fixed electrode 16 and movable electrode 21. As shown in FIG. 20, thus, discharge 53 occurs between fixed electrode 16 and movable electrode 21. A conductive path is formed between fixed electrode 16 and movable electrode 21 by discharge 53, causing movable electrode 21 to become electrically conductive with fixed electrode 16. As a result, the path of the fault current switches from the electrical device to high-speed introduction device 1.

Movable member 41 further presses movable electrode 21 to move movable electrode 21 toward fixed electrode 16. As shown in FIG. 21, movable electrode 21 comes into contact with fixed electrode 16. The electrical conduction between fixed electrode 16 and movable electrode 21 switches from the electrical conduction via discharge 53 to the electrical conduction due to the contact between fixed electrode 16 and movable electrode 21. The fault current continuously flows through high-speed introduction device 1. Thus, the electrical device can be protected from the fault current.

High-speed introduction device 1 of the present embodiment achieves the same effects as those of high-speed introduction device 1 of Embodiment 1, which will be described below.

In high-speed introduction device 1 of the present embodiment, second electrode 3 is movable electrode 21. Voltage generation element 35 is a piezoelectric element and includes the first end portion (end portion 36) and the second end portion (end portion 37) opposite to the first end portion. Non-electrical energy application unit 7 is drive unit 40. Drive unit 40 includes housing 43 and movable member 41 that can move relative to housing 43 and can move movable electrode 21 toward first electrode 2. Housing 43 and movable member 41 have electrical conductivity and are electrically conductive with each other. The first end portion of voltage generation element 35 is in contact with housing 43. The second end portion of voltage generation element 35 is electrically conductive with first electrode 2.

While movable member 41 is moving relative to housing 43, housing 43 receives a reaction force and presses voltage generation element 35. Voltage generation element 35 generates a trigger voltage. This eliminates the need for a high-voltage circuit and a control circuit that controls the high-voltage circuit. High-speed introduction device 1 is less costly and has higher long-term reliability.

### EMBODIMENT 7

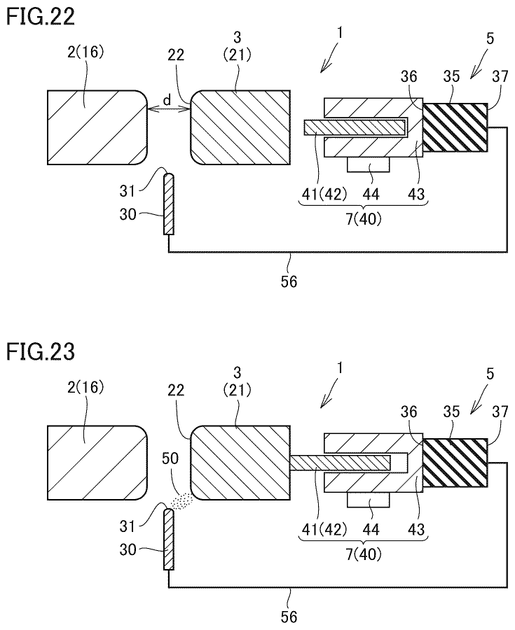

Referring to FIG. 22, high-speed introduction device 1 of Embodiment 7 will be described. High-speed introduction device 1 of the present embodiment has the same configuration as that of high-speed introduction device 1 of Embodiment 6, but differs mainly in the following points.

In the present embodiment, discharge induction mechanism 5 includes trigger electrode 30. Trigger electrode 30 includes end portion 31. End portion 31 of trigger electrode 30 faces the space between first electrode 2 and second electrode 3. The distance between end portion 31 of trigger electrode 30 and end portion 22 of second electrode 3 is smaller than the distance between first electrode 2 and second electrode 3. End portion 37 of voltage generation element 35 is electrically conductive with trigger electrode 30. Specifically, end portion 37 of voltage generation element 35 is electrically connected to trigger electrode 30 through wire 56.

Referring to FIGS. 22 to 25, an operation of high-speed introduction device 1 of the present embodiment will be described.

When no fault current is detected, as shown in FIG. 22, second electrode 3 is distant from first electrode 2 by distance d. Distance d is not less than the insulation distance between first electrode 2 and second electrode 3. Even if an approximately equal voltage to the voltage applied to the electrical device (not shown) connected in parallel to high-speed introduction device 1 is applied between first electrode 2 and second electrode 3, thus, first electrode 2 and second electrode 3 are not electrically conductive with each other. A normal current flows through the electrical device.

When a fault current is detected, an introduction command signal is input to non-electrical energy application unit 7 (e.g., drive unit 40). Moving mechanism 44 moves movable member 41 (movable rod 42) toward second electrode 3. While movable member 41 is moving relative to housing 43, housing 43 receives a reaction force and presses voltage generation element 35. A trigger voltage is generated between end portion 36 and end portion 37 of voltage generation element 35.

As shown in FIG. 23, movable member 41 comes into contact with movable electrode 21 and presses movable electrode 21 toward fixed electrode 16. Movable electrode 21 is electrically connected to end portion 36 of voltage generation element 35 via movable member 41 and housing 43. Trigger electrode 30 is electrically connected to end portion 37 of voltage generation element 35 through wire 56. Thus, a trigger voltage is applied between movable electrode 21 and trigger electrode 30.

The trigger voltage generated in voltage generation element 35 is applied between trigger electrode 30 and second electrode 3. A voltage higher than the breakdown voltage of the medium (e.g., air) between end portion 31 of trigger electrode 30 and second electrode 3 is applied between trigger electrode 30 and second electrode 3. As shown in FIG. 23, thus, first discharge 50 occurs between trigger electrode 30 and second electrode 3.

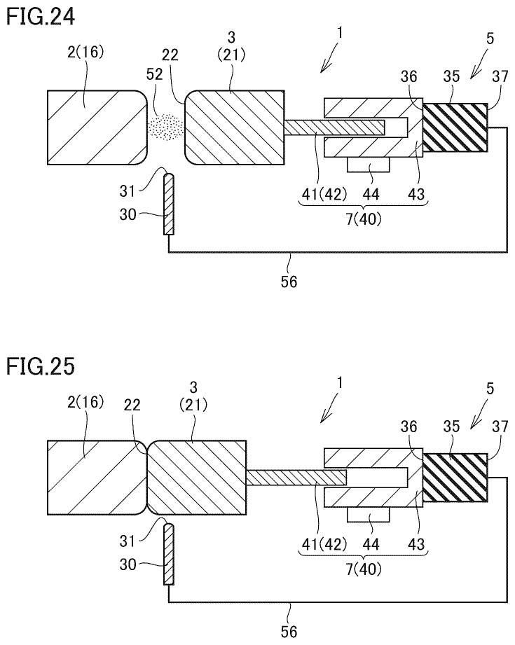

Charged particles are generated between first electrode 2 and second electrode 3 due to first discharge 50. The charged particles reduce the breakdown voltage of the medium between first electrode 2 and second electrode 3. Since first electrode 2 and second electrode 3 are connected in parallel to the electrical device (not shown) to be protected by high-speed introduction device 1, an approximately equal voltage to the voltage applied to the electrical device is applied between first electrode 2 and second electrode 3. The voltage applied between first electrode 2 and second electrode 3 becomes higher than the reduced breakdown voltage of the medium between first electrode 2 and second electrode 3. As shown in FIG. 24, thus, second discharge 52 occurs between first electrode 2 and second electrode 3. A conductive path is formed between first electrode 2 and second electrode 3 by second discharge 52, causing second electrode 3 to become electrically conductive with first electrode 2. As a result, the path of the fault current switches from the electrical device to high-speed introduction device 1.

Movable member 41 further presses movable electrode 21 to move movable electrode 21 toward fixed electrode 16. As shown in FIG. 25, movable electrode 21 comes into contact with fixed electrode 16. The electrical conduction between fixed electrode 16 and movable electrode 21 switches from the electrical conduction via second discharge 52 to the electrical conduction due to the contact between fixed electrode 16 and movable electrode 21. The fault current continuously flows through high-speed introduction device 1. Thus, the electrical device can be protected from the fault current.

High-speed introduction device 1 of the present embodiment achieves the same effects as those of high-speed introduction device 1 of Embodiment 1, which will be described below.

In high-speed introduction device 1 of the present embodiment, second electrode 3 is movable electrode 21. Discharge induction mechanism 5 includes trigger electrode 30. Trigger electrode 30 includes end portion 31 facing the space between first electrode 2 and second electrode 3. The distance between end portion 31 of trigger electrode 30 and second electrode 3 is smaller than the distance between first electrode 2 and second electrode 3. Voltage generation element 35 is a piezoelectric element and includes the first end portion (end portion 36) and the second end portion (end portion 37) opposite to the first end portion. Non-electrical energy application unit 7 is drive unit 40. Drive unit 40 includes housing 43 and movable member 41 that can move relative to housing 43 and move movable electrode 21 toward first electrode 2. Housing 43 and movable member 41 have electrical conductivity and are electrically conductive with each other. The first end portion of voltage generation element 35 is in contact with housing 43. The second end portion of voltage generation element 35 is electrically conductive with trigger electrode 30.

While movable member 41 is moving relative to housing 43, housing 43 receives a reaction force and presses voltage generation element 35. Voltage generation element 35 generates a trigger voltage. This eliminates the need for a high-voltage circuit and a control circuit that controls the high-voltage circuit. High-speed introduction device 1 is less costly and has higher long-term reliability.

### EMBODIMENT 8

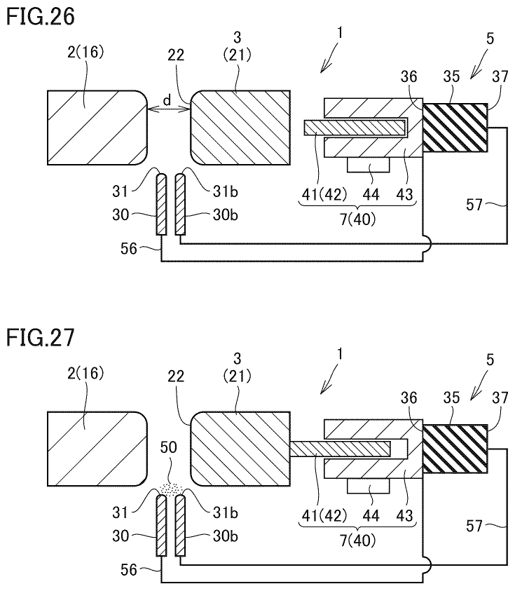

Referring to FIG. 26, high-speed introduction device 1 of Embodiment 8 will be described. High-speed introduction device 1 of the present embodiment has the same configuration as that of high-speed introduction device 1 of Embodiment 6, but differs mainly in the following points.

In the present embodiment, discharge induction mechanism 5 includes trigger electrode 30 and trigger electrode 30b. Trigger electrode 30 includes end portion 31. Trigger electrode 30b includes end portion 31b. End portion 31 of trigger electrode 30 and end portion 31b of trigger electrode 30b face the space between first electrode 2 and second electrode 3. The distance between end portion 31 of trigger electrode 30 and end portion 31b of trigger electrode 30b is smaller than the distance between end portion 31 of trigger electrode 30 and first electrode 2, smaller than the distance between end portion 31 of trigger electrode 30 and second electrode 3, smaller than the distance between end portion 31b of trigger electrode 30b and first electrode 2, and smaller than the distance between end portion 31b of trigger electrode 30b and second electrode 3.

End portion 36 of voltage generation element 35 is electrically conductive with trigger electrode 30. End portion 37 of voltage generation element 35 is electrically conductive with trigger electrode 30b. Specifically, trigger electrode 30 is electrically connected to end portion 36 of voltage generation element 35 through wire 56. Trigger electrode 30b is electrically connected to end portion 37 of voltage generation element 35 through wire 57.

Referring to FIGS. 26 to 29, an operation of high-speed introduction device 1 of the present embodiment will be described.

When no fault current is detected, as shown in FIG. 26, second electrode 3 is distant from first electrode 2 by distance d. Distance d is not less than the insulation distance between first electrode 2 and second electrode 3. Even if an approximately equal voltage to the voltage applied to the electrical device (not shown) connected in parallel to high-speed introduction device 1 is applied between first electrode 2 and second electrode 3, thus, first electrode 2 and second electrode 3 are not electrically conductive with each other. A normal current flows through the electrical device.

When a fault current is detected, an introduction command signal is input to non-electrical energy application unit 7 (e.g., drive unit 40). Moving mechanism 44 moves movable member 41 (movable rod 42) toward second electrode 3. While movable member 41 is moving relative to housing 43, housing 43 receives a reaction force and presses voltage generation element 35. A trigger voltage is generated between end portion 36 and end portion 37 of voltage generation element 35.

As shown in FIG. 27, movable member 41 comes into contact with movable electrode 21 and presses movable electrode 21 toward fixed electrode 16. Movable electrode 21 is electrically connected to end portion 36 of voltage generation element 35 via movable member 41 and housing 43. Trigger electrode 30 is electrically connected to end portion 37 of voltage generation element 35 through wire 56. Thus, a trigger voltage is applied between movable electrode 21 and trigger electrode 30.

The trigger voltage generated in voltage generation element 35 is applied between trigger electrode 30 and trigger electrode 30b. A voltage higher than the breakdown voltage of the medium (e.g., air) between end portion 31 of trigger electrode 30 and end portion 31b of trigger electrode 30b is applied between trigger electrode 30 and trigger electrode 30b. As shown in FIG. 27, thus, first discharge 50 occurs between trigger electrode 30 and trigger electrode 30b.

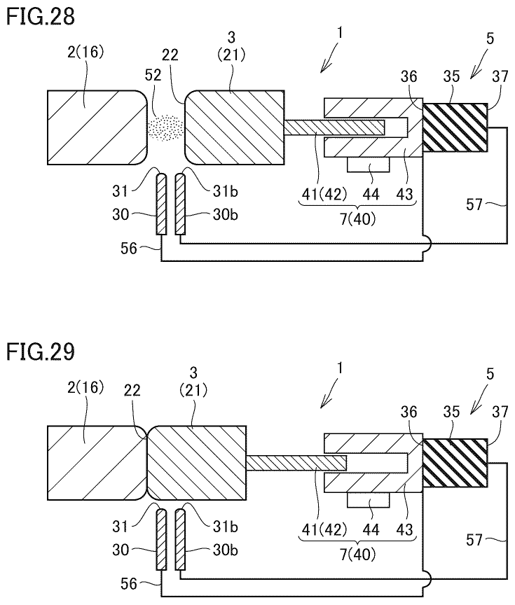

Charged particles are generated between first electrode 2 and second electrode 3 due to first discharge 50. The charged particles reduce the breakdown voltage of the medium between first electrode 2 and second electrode 3. Since first electrode 2 and second electrode 3 are connected in parallel to the electrical device (not shown) to be protected by high-speed introduction device 1, an approximately equal voltage to the voltage applied to the electrical device is applied between first electrode 2 and second electrode 3. The voltage applied between first electrode 2 and second electrode 3 becomes higher than the reduced breakdown voltage of the medium between first electrode 2 and second electrode 3. As shown in FIG. 28, thus, second discharge 52 occurs between first electrode 2 and second electrode 3. A conductive path is formed between first electrode 2 and second electrode 3 by second discharge 52, causing second electrode 3 to become electrically conductive with first electrode 2. As a result, the path of the fault current switches from the electrical device to high-speed introduction device 1.

Movable member 41 further presses movable electrode 21 to move movable electrode 21 toward fixed electrode 16. As shown in FIG. 29, movable electrode 21 comes into contact with fixed electrode 16. The electrical conduction between fixed electrode 16 and movable electrode 21 switches from the electrical conduction via second discharge 52 to the electrical conduction due to the contact between fixed electrode 16 and movable electrode 21. The fault current continuously flows through high-speed introduction device 1. Thus, the electrical device can be protected from the fault current.

High-speed introduction device 1 of the present embodiment achieves the same effects as those of high-speed introduction device 1 of Embodiment 1, which will be described below.

In high-speed introduction device 1 of the present embodiment, second electrode 3 is movable electrode 21. Discharge induction mechanism 5 includes the first trigger electrode (trigger electrode 30) and the second trigger electrode (trigger electrode 30b). End portion 31 of the first trigger electrode and end portion 31b of the second trigger electrode face the space between first electrode 2 and second electrode 3. Voltage generation element 35 is a piezoelectric element and includes the first end portion (end portion 36) and the second end portion (end portion 37) opposite to the first end portion. Non-electrical energy application unit 7 is drive unit 40. Drive unit 40 includes housing 43 and movable member 41 that can move relative to housing 43 and move movable electrode 21 toward first electrode 2. Housing 43 and movable member 41 have electrical conductivity and are electrically conductive with each other. The first end portion of voltage generation element 35 is electrically conductive with the first trigger electrode. The second end portion of voltage generation element 35 is electrically conductive with the second trigger electrode.

While movable member 41 is moving relative to housing 43, housing 43 receives a reaction force and presses voltage generation element 35. Voltage generation element 35 generates a trigger voltage. This eliminates the need for a high-voltage circuit and a control circuit that controls the high-voltage circuit. High-speed introduction device 1 is less costly and has higher long-term reliability.

### EMBODIMENT 9

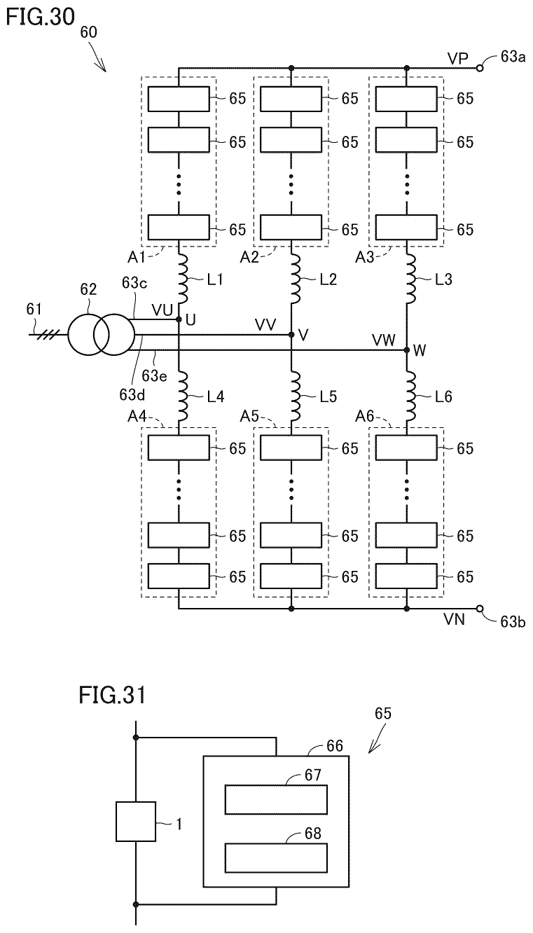

Referring to FIGS. 30 and 31, a power converter 60 of Embodiment 9 will be described. Power converter 60 is, for example, an alternating-current (AC)/direct-current (DC) power converter that converts DC power into three-phase AC power.

Referring to FIG. 30, power converter 60 includes a positive voltage terminal 63a, a negative voltage terminal 63b, AC terminals 63c, 63d, 63e, arms A1, A2, A3, A4, A5, A6, and reactors L1, L2, L3, L4, L5, L6. Each of arms A1, A2, A3, A4, A5, A6 includes a plurality of power control circuits 65 connected in series. Power control circuit 65 is an application example of high-speed introduction device 1 of any one of Embodiment 1 and the modifications thereof.

Positive voltage terminal 63a and negative voltage terminal 63b are connected to a load (not shown). The load is, for example, a DC power supply or a motor drive inverter. AC terminals 63c, 63d, 63e are connected to three secondary terminals of a three-phase transformer 62, respectively. A primary terminal of three-phase transformer 62 is connected to a three-phase power transmission line of an AC power system 61.

Three-phase AC power of AC power system 61 is supplied to power converter 60 via three-phase transformer 62. Power converter 60 converts the three-phase AC power into DC power. The converted DC power is supplied to the load connected to positive voltage terminal 63a and negative voltage terminal 63b. Thus, DC power is supplied from AC power system 61 to the load.

One terminal of arm A1 is connected to positive voltage terminal 63a, and the other terminal of arm A1 is connected to one terminal of reactor L1. One terminal of arm A2 is connected to positive voltage terminal 63a, and the other terminal of arm A2 is connected to one terminal of reactor L2. One terminal of arm A3 is connected to positive voltage terminal 63a, and the other terminal of arm A3 is connected to one terminal of reactor L3. The other terminal of reactor L1 is connected to AC terminal 63c. The other terminal of reactor L2 is connected to AC terminal 63d. The other terminal of reactor L3 is connected to AC terminal 63e.

One terminal of arm A4 is connected to negative voltage terminal 63b, and the other terminal of arm A4 is connected to one terminal of reactor L4. One terminal of arm A5 is connected to negative voltage terminal 63b, and the other terminal of arm A5 is connected to one terminal of reactor L5. One terminal of arm A6 is connected to negative voltage terminal 63b, and the other terminal of arm A6 is connected to one terminal of reactor L6. The other terminal of reactor L4 is connected to AC terminal 63c. The other terminal of reactor L5 is connected to AC terminal 63d. The other terminal of reactor L6 is connected to AC terminal 63e.

A positive DC voltage VP is supplied to positive voltage terminal 63a. A negative DC voltage VN is supplied to negative voltage terminal 63b. A U-phase AC voltage VU is supplied to AC terminal 63c. A V-phase AC voltage VV is supplied to AC terminal 63d. A W-phase AC voltage VW is supplied to AC terminal 63e. The phases of three-phase AC voltages VU, VV, VW are out of phase with each other by 120 degrees.

Arms A1, A4 constitute a U-phase module that performs power conversion between U-phase AC voltage VU and DC voltages VP, VN. Arms A2, A5 constitute a V-phase module that performs power conversion between V-phase AC voltage VV and DC voltages VP, VN. Arms A3, A6 constitute a W-phase module that performs power conversion between W-phase AC voltage VW and DC voltages VP, VN.

Reactor L1 controls a current flowing through arm A1. Reactor L2 controls a current flowing through arm A2. Reactor L3 controls a current flowing through arm A3. Reactor LA controls a current flowing through arm A4. Reactor L5 controls a current flowing through arm A5. Reactor L6 controls a current flowing through arm A6. Reactors L1, L2, L3, L4, L5, L6 suppress a circulating current flowing between the U-phase module, the V-phase module, and the W-phase module when the amplitudes of U-phase AC voltage VU, V-phase AC voltage VV, and W-phase AC voltage VW are different.

Referring to FIG. 31, power control circuit 65 includes a module circuit 66, high-speed introduction device 1 of any one of Embodiment 1 and the modifications thereof, and peripheral components (not shown). High-speed introduction device 1 is electrically connected in parallel to module circuit 66.

Module circuit 66 includes a main circuit 67 and a control circuit 68. Main circuit 67 includes a switching element (not shown), such as an insulated gate bipolar transistor (IGBT), a diode (not shown), and a capacitor (not shown). By switching the switching element between an ON state and an OFF state, AC power is converted into DC power. Control circuit 68 controls main circuit 67.

The peripheral components are disposed around module circuit 66. The peripheral components include, for example, a jig (not shown), a busbar (not shown), and a housing (not shown). The jig fixes the electronic components (e.g., switching element, diode, and capacitor) that constitute main circuit 67. The busbar is connected to a terminal of main circuit 67. The housing accommodates control circuit 68 and protects control circuit 68.

While module circuit 66 is operating normally, a current flows through module circuit 66. When a failure occurs in module circuit 66, high-speed introduction device 1 operates. The current flows through high-speed introduction device 1 while bypassing the faulty module circuit 66. The faulty module circuit 66 can be excluded from the current path. Thus, the operation of the system (e.g., AC power system 61) at the level higher than that of power control circuit 65 can be continued without being affected by the faulty module circuit 66.

Further, when a failure occurs in module circuit 66, an arc may occur in module circuit 66. An increase in the arc duration increases the likelihood of damage to at least one of main circuit 67, control circuit 68, or peripheral components. In the present embodiment, since high-speed introduction device 1 operates quickly when a failure occurs in module circuit 66, the arc duration decreases. Damage to main circuit 67, control circuit 68, and the peripheral components can be prevented. The explosion-proof performance of power control circuit 65 can be improved.

The effects of power control circuit 65 of the present embodiment will be described.

Power control circuit 65 of the present embodiment includes module circuit 66 and high-speed introduction device 1 of any one of Embodiments 1 to 5. High-speed introduction device 1 is electrically connected in parallel to module circuit 66.

Power control circuit 65 includes high-speed introduction device 1. Thus, power control circuit 65 is less costly and has higher long-term reliability.

It should be understood that Embodiments 1 to 9 disclosed herein have been presented for the purpose of illustration and non-restrictive in every respect. It is therefore intended that the scope of the present disclosure is defined by claims, not only by the above description, and encompasses all modifications and variations equivalent in meaning and scope to the claims.

### REFERENCE SIGNS LIST

1 high-speed introduction device; 2 first electrode; 3 second electrode; 5 discharge induction mechanism; 7 non-electrical energy application unit; 10 container; 11 first main electrode; 12 second main electrode; 12a flange portion; 12b cylindrical portion; 12c through hole; 13 insulating hollow body; 14 insulated space; 16, 20 fixed electrode; 21 movable electrode; 22, 23 end portion; 24 hole; 26 conductive plate; 28 sliding member; 30, 30b trigger electrode; 31, 31b, 32 end portion; 33 insulating member; 35 voltage generation element; 36, 37 end portion; 40 drive unit; 41 movable member; 42 movable rod; 43 housing; 44 moving mechanism; 45 pressing member; 46 spring; 47 stopper; 50 first discharge; 52 second discharge; 53 discharge; 56, 57 wire; 60 power converter; 61 AC power system; 62 three-phase transformer; 63a positive voltage terminal; 63b negative voltage terminal; 63c, 63d, 63e AC terminal; 65 power control circuit; 66 module circuit; 67 main circuit; 68 control circuit; A1, A2, A3, A4, A5, A6 arm; L1, L2, L3, L4, L5, L6 reactor.

1. A high-speed introduction device comprising:
a first electrode;
a second electrode spaced apart from the first electrode; and
a discharge induction mechanism to induce a discharge between the first electrode and the second electrode,
wherein the discharge induction mechanism includes a voltage generation element and a non-electrical energy application unit to apply non-electrical energy to the voltage generation element.

2. The high-speed introduction device according to claim 1, wherein
the discharge induction mechanism includes a trigger electrode connected to the voltage generation element,
the second electrode and the trigger electrode are electrically connected to the voltage generation element,
the trigger electrode includes an end portion facing a space between the first electrode and the second electrode, and
a distance between the end portion of the trigger electrode and the second electrode is smaller than a distance between the first electrode and the second electrode.

3. The high-speed introduction device according to claim 2, wherein the voltage generation element is disposed in a hole of the second electrode.

4. The high-speed introduction device according to claim 2, further comprising an insulating member,
wherein the insulating member is disposed between the trigger electrode and the second electrode.

5. The high-speed introduction device according to claim 2, wherein
the voltage generation element includes a first end portion and a second end portion opposite to the first end portion,
the discharge induction mechanism includes a conductive plate,
the trigger electrode is in contact with the first end portion, and
the conductive plate is in contact with the second end portion and the second electrode.

6. The high-speed introduction device according to claim 2, wherein the end portion of the trigger electrode is disposed between the first electrode and the second electrode.

7. The high-speed introduction device according to claim 1, wherein the first electrode and the second electrode are electrically connected to the voltage generation element.

8. The high-speed introduction device according to claim 1, wherein
the discharge induction mechanism includes a first trigger electrode and a second trigger electrode,
the first trigger electrode and the second trigger electrode are electrically connected to the voltage generation element, and
an end portion of the first trigger electrode and an end portion of the second trigger electrode face a space between the first electrode and the second electrode.

9. The high-speed introduction device according to claim 1, wherein
the voltage generation element is a piezoelectric element, and
the non-electrical energy application unit is a drive unit including a movable member to apply mechanical energy to the piezoelectric element.

10. The high-speed introduction device according to claim 9, wherein
the second electrode is a movable electrode, and
the movable member moves the movable electrode toward the first electrode.

11. The high-speed introduction device according to claim 10, wherein the movable member includes a movable rod, a pressing member to press the movable electrode, and an elastic member connected to the movable rod and the pressing member.

12. The high-speed introduction device according to claim 10, wherein
the movable member includes a movable rod, a pressing member to press the movable electrode, and a force-stored spring, and
the pressing member is pressed by the movable rod and is connected to the force-stored spring.

13. The high-speed introduction device according to claim 1, wherein
the second electrode is a movable electrode,
the voltage generation element is a piezoelectric element and includes a first end portion and a second end portion opposite to the first end portion,
the non-electrical energy application unit is a drive unit,
the drive unit includes a housing and a movable member to move relative to the housing and move the movable electrode toward the first electrode,
the housing and the movable member have electrical conductivity and are electrically conductive with each other,
the first end portion is in contact with the housing, and
the second end portion is electrically conductive with the first electrode.

14. The high-speed introduction device according to claim 1, wherein
the second electrode is a movable electrode,
the discharge induction mechanism includes a trigger electrode,
the trigger electrode includes an end portion facing a space between the first electrode and the second electrode,
a distance between the end portion of the trigger electrode and the second electrode is smaller than a distance between the first electrode and the second electrode,
the voltage generation element is a piezoelectric element and includes a first end portion and a second end portion opposite to the first end portion,
the non-electrical energy application unit is a drive unit,
the drive unit includes a housing and a movable member to move relative to the housing and move the movable electrode toward the first electrode,
the housing and the movable member have electrical conductivity and are electrically conductive with each other,
the first end portion is in contact with the housing, and
the second end portion is electrically conductive with the trigger electrode.

15. The high-speed introduction device according to claim 1, wherein
the second electrode is a movable electrode,
the discharge induction mechanism includes a first trigger electrode and a second trigger electrode,
an end portion of the first trigger electrode and an end portion of the second trigger electrode face a space between the first electrode and the second electrode,
the voltage generation element is a piezoelectric element and includes a first end portion and a second end portion opposite to the first end portion,
the non-electrical energy application unit is a drive unit,
the drive unit includes a housing and a movable member to move relative to the housing and move the movable electrode toward the first electrode,
the housing and the movable member have electrical conductivity and are electrically conductive with each other,
the first end portion is electrically conductive with the first trigger electrode, and
the second end portion is electrically conductive with the second trigger electrode.

16. A power control circuit comprising:
a module circuit; and
the high-speed introduction device according to claim 1,
wherein the high-speed introduction device is electrically connected in parallel to the module circuit.
